(19) United States
(12) Patent Application Publication
(10) Pub. No.: US 2015/0088575 A1
(43) Pub. Date: Mar. 26, 2015

(54) SYSTEM AND METHOD FOR SCHEDULING APPOINTMENTS

(71) Applicant: Yocale Network Corporation, North Vancouver (CA)

(72) Inventors: Arash Asli, West Vancouver (CA); Ehab Samy, North Vancouver (CA)

(21) Appl. No.: 14/497,316

(22) Filed: Sep. 25, 2014

Related U.S. Application Data
(60) Provisional application No. 61/882,573, filed on Sep. 25, 2013.

(51) Int. Cl. G06Q 10/06; H04L 29/08

(52) U.S. Cl. CPC G06Q 10/06314; H04L 67/26
USPC 705/7.19

(57) ABSTRACT

A method for scheduling appointments allows a consumer to schedule a location-based appointment in real time. A consumer request to schedule an appointment is sent from a first processing device. The consumer request may include a service provider parameter, a location parameter, and a time parameter. The request to schedule an appointment is received at a server and a database is searched for a service provider able to meet the consumer request. A list of service providers that are able to meet the consumer request is displayed on the first processing device. A push-notification is sent from the first processing device to a second processing device to book the appointment with a selected service provider. A push-notification is sent from the second processing device to the first processing device to confirm or cancel the appointment.

### BACKGROUND OF THE INVENTION

1. Field of the Invention

The present invention relates to a system and method for scheduling appointments and, in particular, to a system and method for scheduling appointments which allows consumers and service providers to schedule and cancel appointments over a computer network in real time.

2. Description of the Related Art

It is known from U.S. Pat. No. 7,188,073 to Tam et al. to schedule appointments over a computer network by sending electronic notifications pertaining to the scheduling of appointments to consumers and service providers. Electronic notifications pertaining to scheduling appointments may also be sent to service providers that are not registered to receive online requests for appointments. The electronic notifications may be in the form of electronic mail.

It is known from U.S. Pat. No. 7,590,550 to Schoenberg to connect consumers with service providers over a computer network. A request is received from a consumer of services to consult with a service provider having a service provider profile that satisfies at least some attributes in a set of attributes that define a suitable service provider. An available service provider satisfying at least some of the attributes in the set of attributes is then identified, and a communication channel is provided to establish a communication between the consumer of services and the identified service provider.

It is known from United States Patent Application Publication Number 2014/0164043 in the name of Jordan to schedule appointments in real time over a computer network. A requested appointment including a requested appointment location and information defining at least one period of time is received from a consumer. Computer processor instructions are executed to identify at least one current appointment and location during the period. Still more computer processor instructions are executed to determine an interval of time between the current appointment and the requested appointment based at least in part on the location of the current appointment and the requested appointment location, and further to determine at least one available time option for scheduling the requested appointment based at least in part on the interval of time. The available time options for scheduling the requested appointment are then returned to the consumer.

There however remains a need for a system and method which allows consumers and service providers to schedule and cancel appointments over a computer network in real time.

### SUMMARY OF THE INVENTION

There is accordingly provided a method of scheduling an appointment. A consumer request to schedule an appointment is sent from a first processing device. The consumer request may include a service provider parameter, a location parameter, and a time parameter. The request to schedule an appointment is received at a server and a database is searched for a service provider able to meet the consumer request. A list of service providers that are able to meet the consumer request is displayed on the first processing device. A push-notification is sent from the first processing device to a second processing device to book the appointment with a selected service provider. A push-notification is sent from the second processing device to the first processing device to confirm or cancel the appointment. A push-notification may be sent from the first processing device to the second processing device to notify the service provider that the consumer will not arrive on time for the appointment. A push-notification may be sent from the second processing device to the first processing device to cancel the appointment. A push-notification may be sent from the second processing device to the first processing device to suggest a change to the appointment.

### BRIEF DESCRIPTIONS OF DRAWINGS

The invention will be more readily understood from the following description of the embodiments thereof given, by way of example only, with reference to the accompanying drawings, in which:

FIG. 1 is a schematic of an improved appointment scheduling system;

FIGS. 2A to 2E are screenshots showing the requesting of an appointment with a service provider;

FIG. 3 is a screenshot showing search results of available times for appointments with service providers;

FIG. 4 is a screenshot showing the selecting of a service provider and a time to schedule an appointment;

FIG. 5 is a screenshot showing the confirming of a scheduled appointment;

FIG. 6 is a screenshot showing a push-notification of a request for an instant appointment sent to a service provider; and

FIG. 7 is a flowchart showing a logic of the appointment scheduling system.

### DESCRIPTIONS OF THE PREFERRED EMBODIMENTS

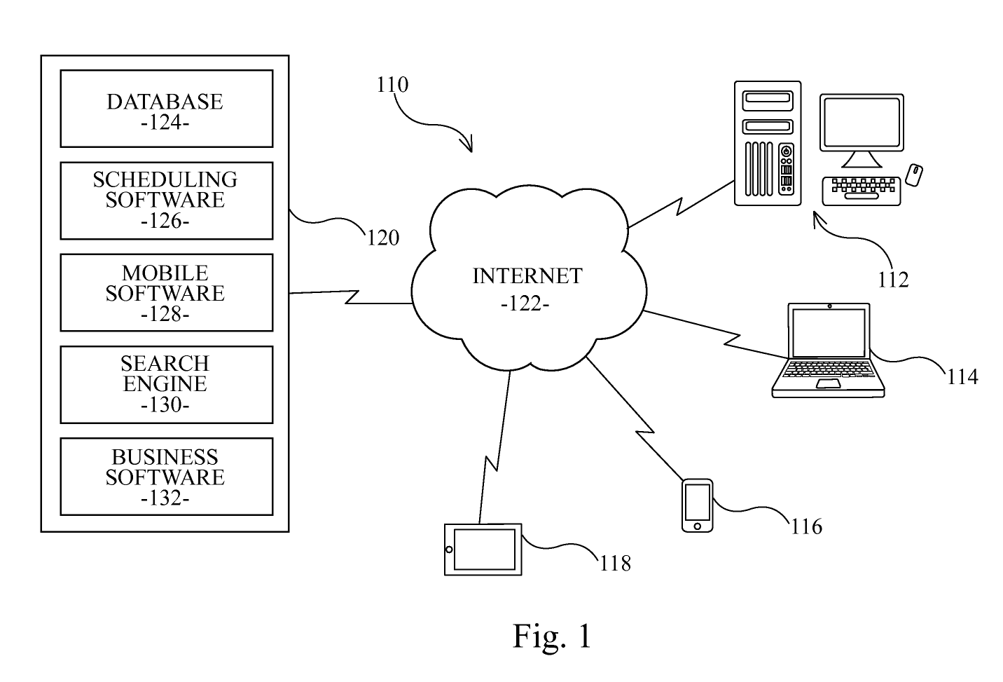

Referring to the drawings and first to FIG. 1, an improved appointment scheduling system 110 is shown. The appointment scheduling system 110 shown in

FIG. 1 comprises a plurality of processing devices which, in this example, include a desktop computer 112, a laptop computer 114, a smart phone 116, an automobile computer 118, and a server 120. However, in other examples, the appointment scheduling system may include any number and type of known processing devices. The desktop computer 112, the laptop computer 114, the smart phone 116, the automobile computer 118, and the server 120 are each in communication with a network which, in this example, is the Internet 122 but may alternatively be any suitable local area network (LAN) or wide area network (WAN). The desktop computer 112, the laptop computer 114, the smart phone 116, and the automobile computer 118 may each communicate with the server 120 over the Internet 122.

The server 120 supports a database 124 which stores service provider profiles and consumer profiles. The service provider profiles may include a variety of information but include at least a unique service provider identifier, a name of the service provider, a location of the service provider, a service provided by the service provider (e.g. chiropractic services, mechanic services, etc.), and an availability of the service provider.

The consumer profiles may likewise include a variety of information but include at least a unique consumer identifier. Other information included in the service provider profiles may include certifications or qualifications of the service provider, consumer reviews of the service provider, a trust rating of the service provider, and web pages of the service provider. Other information included in the consumer profiles may include a name of the consumer, a trust rating of the consumer, preferred service providers of the consumer, reviews of service providers written by the consumer, wish lists of the consumer, and search histories of the consumer.

The desktop computer 112 and the laptop computer 114 are each a workstation for a service provider and function as a user interface for an appointment scheduling software module 126 supported by the server 120. The appointment scheduling software module 126 will allow a service provider to schedule and manage appointments. The smart phone 116 and the automobile computer 118 are each a mobile processing device for a consumer and function as a user interface for mobile application software 128 supported by the server 120. The mobile application software 128 allows a consumer to request and schedule an appointment with a service provider. The server 120 also supports search engine 130 which searches the database 124 in response to a request from a consumer to schedule an appointment with a service provider. The search engine 130 returns a list of available service providers based on parameters of the request to schedule an appointment. The search engine 130 may also search the Internet 122 to include service providers not found in the database 124 in the search results and/or include aggregated reviews and trust ratings of service providers from third party websites, for example, Yelp™, Yahoo! Local™, or Google Places™.

The database 124 may be populated with service provider profiles when service providers register to use the appointment scheduling software module 126 supported by the server 120. The server 120 may further support a business management software module 132 to allow service providers to manage other aspects of their business including, but not limited to, marketing, record keeping, financials, and analytics.

Registration to use of the business management software module 132 may be a requirement for service providers to register to use the appointment scheduling software module 126. Alternatively, service providers may register to use the appointment scheduling software module 126 as a standalone module. The database 124 may be populated with consumer profiles when consumers register with the server 120 to request and schedule an appointment with a service provider. The consumer profiles may be generated using existing social networking profiles from, for example, Facebook™, Twitter™, or LinkedIn™.

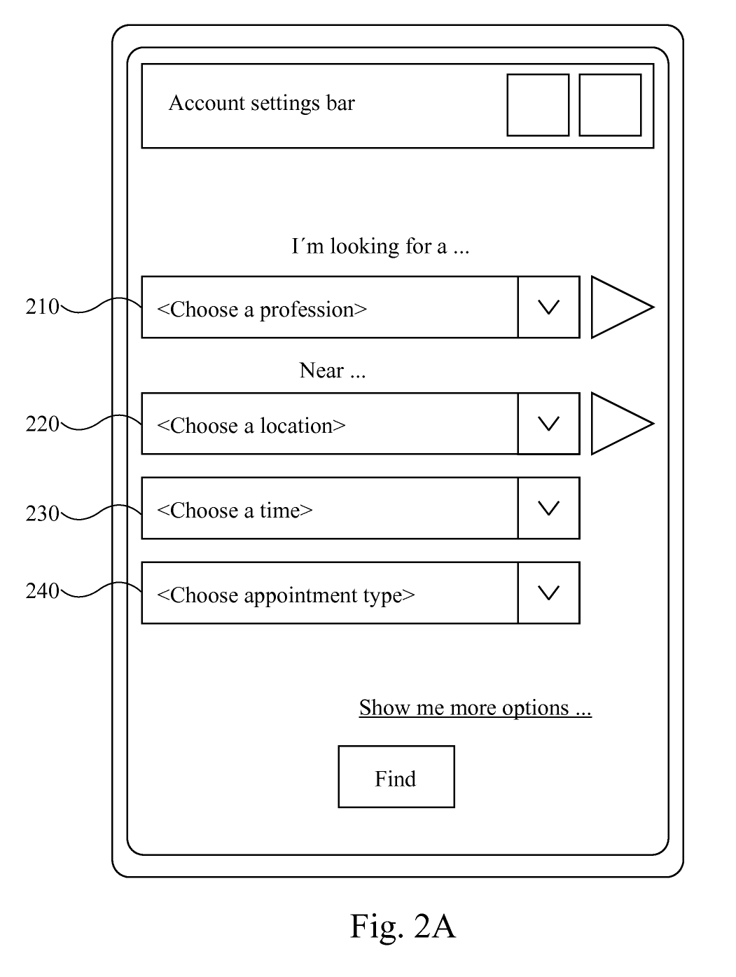

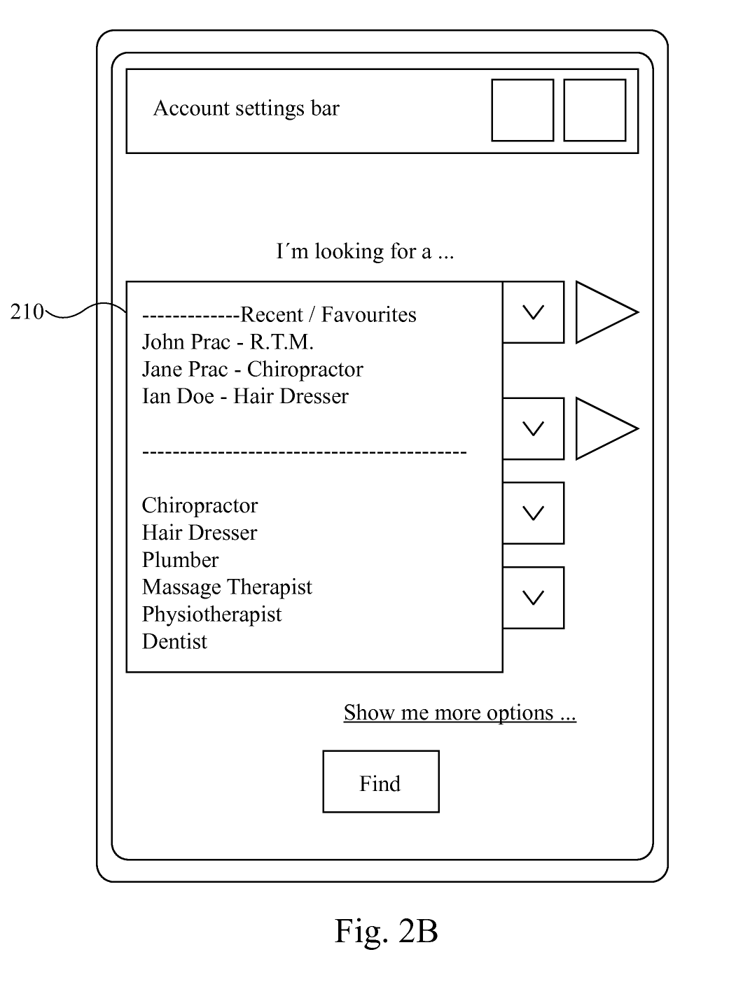

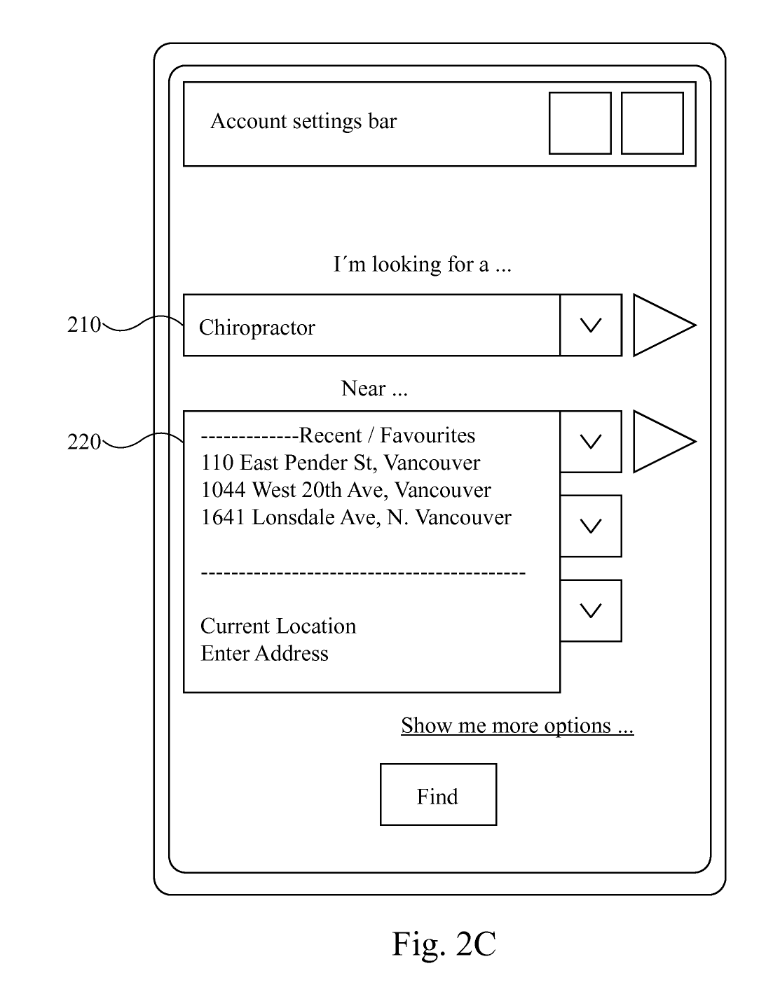

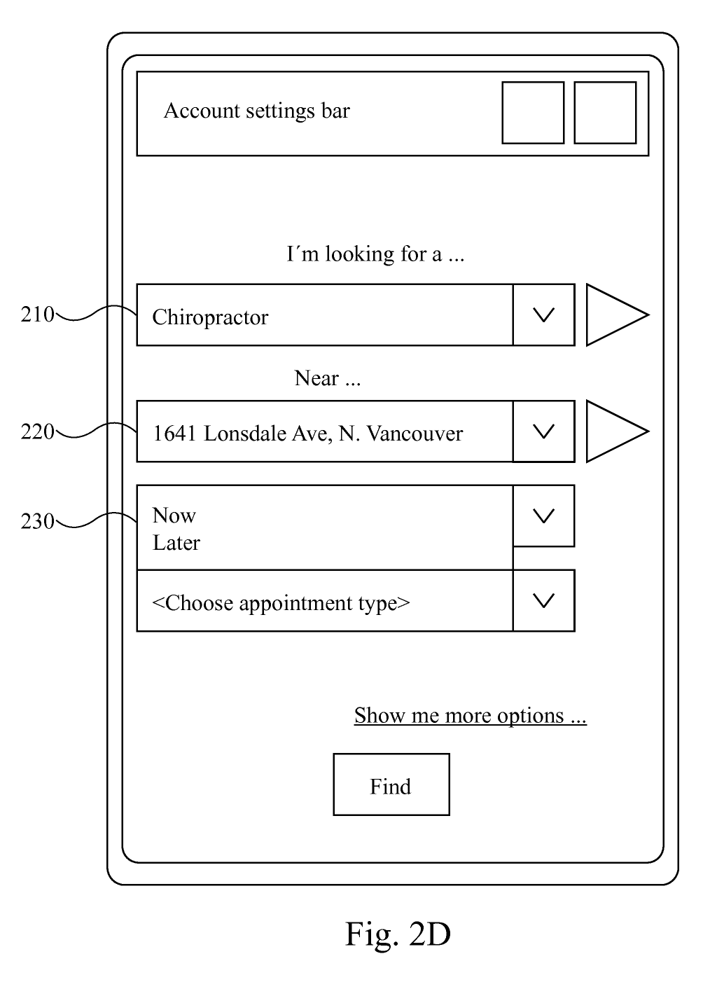

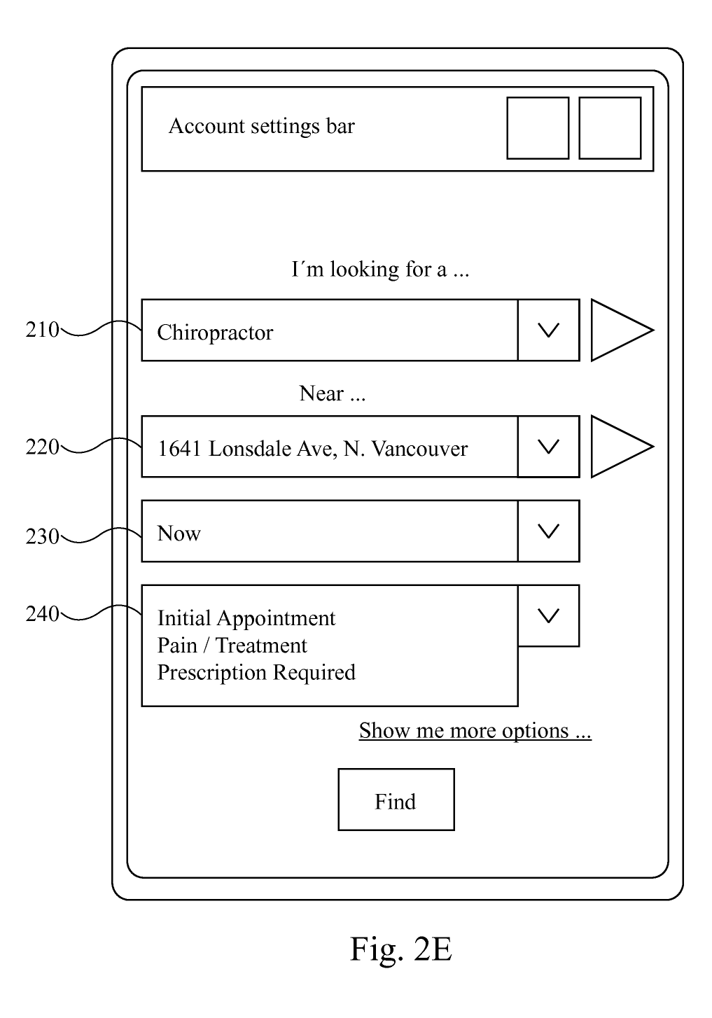

A consumer uses a mobile processing device such as the smart phone 116, shown in FIG. 1, to request an appointment with a service provider. The smart phone 116 functions as a user interface for mobile application software 128 to allow the consumer to enter search parameters as best shown in FIGS. 2A to 2E. The search parameters may be a variety of parameters but include at least a type of service provider 210, a desired location for the appointment 220, and a desired time for the appointment 230. The search parameters may also include other parameters such as a specific type of appointment 240. In the example of FIGS. 2A to 2E, the consumer has requested an appointment with a chiropractor near 1641 Lonsdale Ave, N. Vancouver. The request is sent over the Internet 122 to the server 120, both of which are shown in FIG. 1. The search engine 130 then searches the database 124 for service providers able to meet the request.

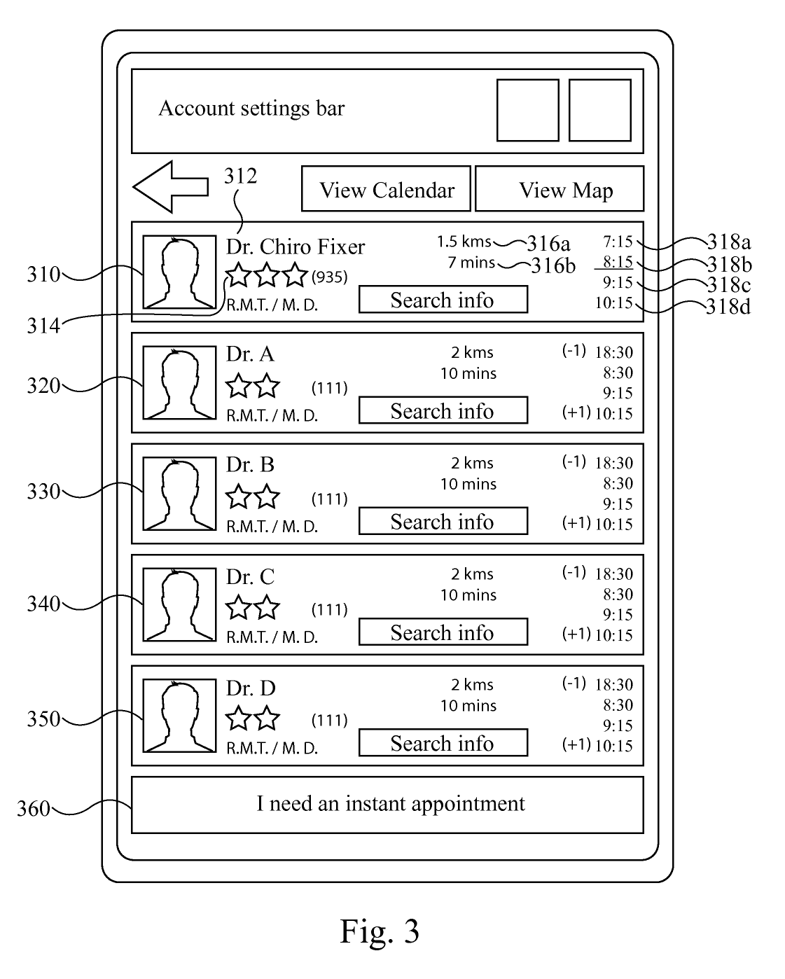

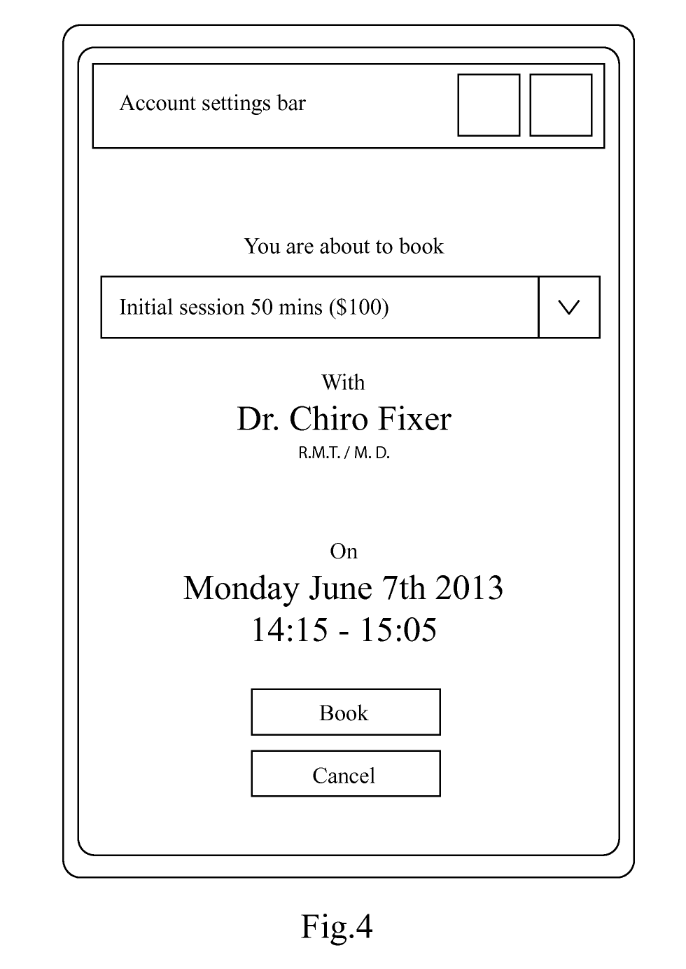

The search results, shown in FIG. 3, are sent over the Internet 122 to the smart phone 116 and may include information related to a plurality of service providers 310, 320, 330, 340 and 350 that are able to meet the request. The information displayed for each of the service providers 310, 320, 330, 340 and 350 is substantially the same. Accordingly, only the information displayed for one of the service providers 310 is discussed in detail herein with the understanding that the information displayed for the other service providers 320, 330, 340 and 350 is substantially the same. In FIG. 3, the information displayed for the said one of the service providers 310 includes a name of the service provider 312, a trust rating of the service provider 314, a location of the service provider including a distance 316a and a time 136b to the service provider based on a location of the consumer, and times 318a, 318b, 318c, and 318d that the service provider is available for an appointment. Based on the search results the consumer may select a time with a service provider to book an appointment as shown in FIG. 4.

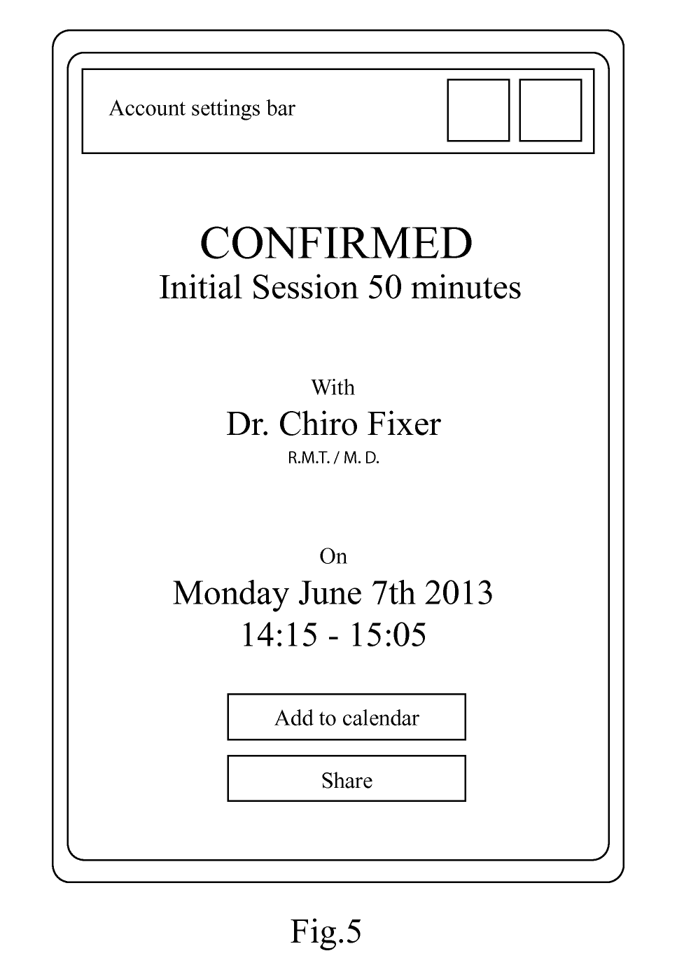

A push-notification that a consumer has selected a time to schedule an appointment with a service provider is sent to the service provider in real time. The service provider may then confirm their availability and schedule the appointment in real time as shown in FIG. 5. The consumer may then add the scheduled appointment to their calendar or share the appointment on a social network. Real time communication between the consumer and the service provider allows for appointments to be scheduled instantaneously. This not only provides the advantage of allowing consumers to efficiently and effectively schedule appointments but also allows consumers to schedule appointments when time unexpectedly becomes available in their own calendar.

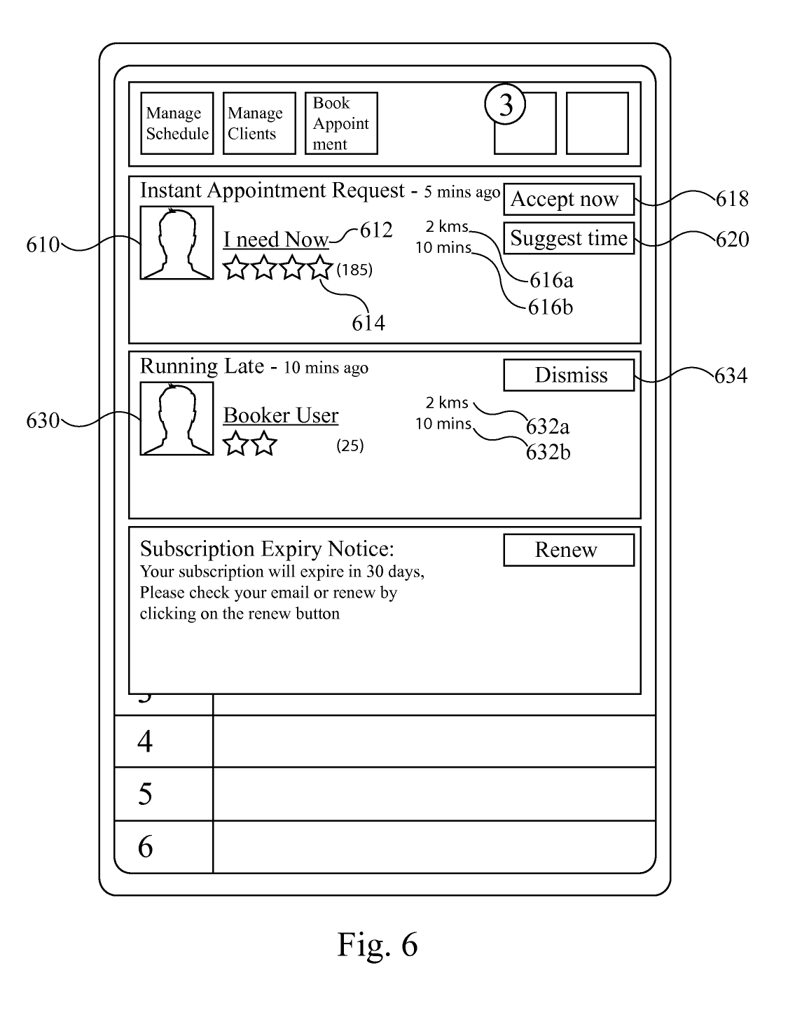

Referring back to FIG. 3, there may be an INSTANT APPOINTMENT icon 360 in the search results which allows a consumer to request an instant appointment with a service provider. A push-notification of the request for an instant appointment is sent to service providers. The request for instant appointment notification 610 is shown in FIG. 6. The request for instant appointment notification 610 may include a name of the consumer 612, a trust rating of the consumer 614, a location of the consumer including a distance 616a and a time 616b that the consumer is away from the service provider. The display of the push-notification request may also include an ACCEPT NOW icon 618 for the service provider to click in order to confirm their availability. The display of the push-notification request may also include a SUGGEST TIME icon 620 for the service provider to click to indicate that they are not available at the requested time but suggest another time to schedule an appointment. The consumer may then either schedule the appointment or cancel the request for an instant appointment based on the response of the service provider.

Real time communication between the consumer and the service provider within the appointment scheduling system 110 also allows the service provider to track the consumers when they are running late and will not arrive on time for the appointment. For example, a delay notification 630 may include a location of the consumer including a distance 632a and a time 632b that the consumer is away from the service provider. The delay notification 630 may also include an icon 634 for the service provider to dismiss or cancel the appointment if the consumer will not arrive in time to complete the appointment within the scheduled time. A push-notification of the dismissal or cancellation of the scheduled appointment will be sent to the consumer.

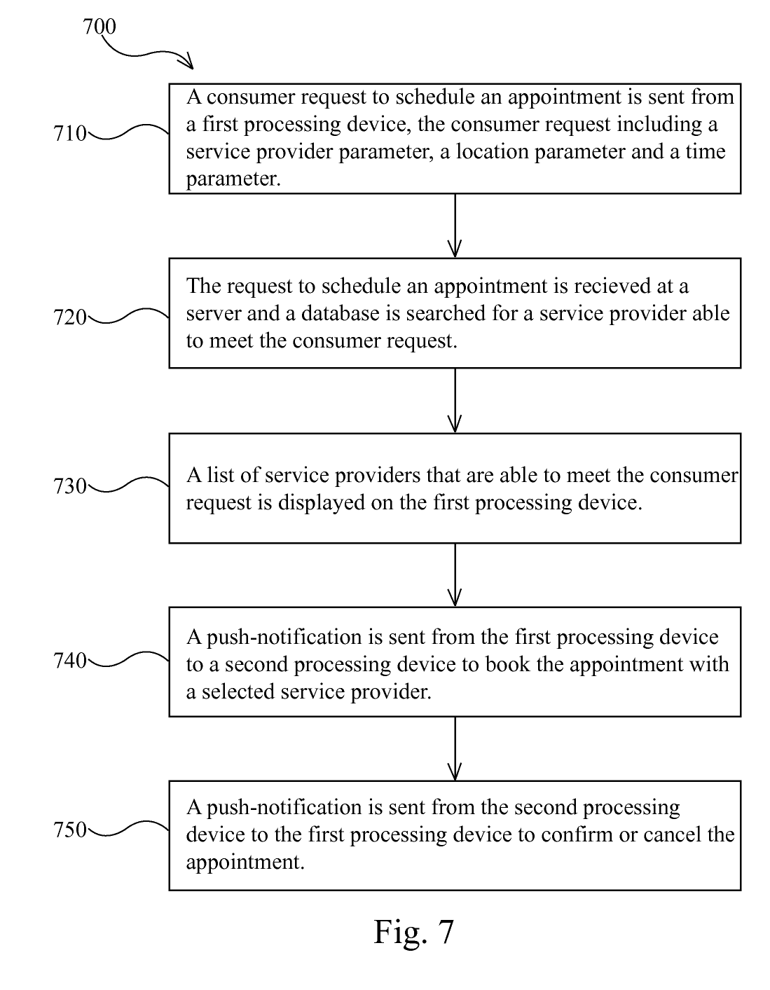

FIG. 7 shows a logic 700 of the appointment scheduling system 110 of FIG. 1. A consumer request to schedule an appointment is sent from a first processing device at step 710. The consumer request includes a service provider parameter, a location parameter, and a time parameter in this example. The request to schedule an appointment is received at a server and a database is searched for a service provider able to meet the consumer request at step 720. A list of service providers that are able to meet the consumer request is displayed on the first processing device at step 730. A push-notification is sent from the first processing device to a second processing device to book the appointment with a selected service provider at step 740. A push-notification is sent from the second processing device to the first processing device to confirm or cancel the appointment at step 750.

The appointment scheduling system 110 of FIG. 1 may allow consumers to schedule maintenance of automobiles based on the location of service providers which most closely match the requirements of the automobile manufacturer.

The appointment scheduling system 110 of FIG. 1 may also allow consumers to schedule an appointment within a time range rather than a selected time. For example, if a service provider has an eight hour work day but only has six hours of work, a consumer can schedule two hours of time with the service provider that work day. This may be useful in a situation where a mechanic has six hours of work and a consumer requires service to their vehicle that can be completed in less than two hours.

The consumer may schedule two hours of the time with the mechanic within the eight hour work day. The consumer would drop off their vehicle at the beginning of the work day and return at the end of the work day to pick up the serviced vehicle.

The appointment scheduling system 110 of FIG. 1 may further allow consumers to automatically schedule multiple appointments in a given geographic area or time range. The appointment scheduling system 110 will automatically provide the consumer with a list of available service providers based on a location and schedule of the consumer.

It will be understood by a person skilled in the art that many of the details provided above are by way of example only, and are not intended to limit the scope of the invention which is to be determined with reference to the following claims.

What is claimed is:

1. A method of scheduling an appointment comprising:
sending a consumer request to schedule an appointment from a first processing device;
receiving the request to schedule an appointment at a server and searching a database for a service provider able to meet the consumer request;
displaying on the first processing device a list of service providers that are able to meet the consumer request;
sending a push-notification from the first processing device to a second processing device to book the appointment with a selected service provider; and
sending a push-notification from the second processing device to the first processing device to confirm the appointment.

2. The method as claimed in claim 1 further including sending a push-notification from the first processing device to the second processing device to notify the service provider that the consumer will not arrive on time for the appointment.

3. The method as claimed in claim 2 further including sending a push-notification from the second processing device to the first processing device to cancel the appointment.

4. The method as claimed in claim 1 further including sending a push-notification from the second processing device to the first processing device to cancel the appointment.

5. The method as claimed in claim 1 further including sending a push-notification from the second processing device to the first processing device to suggest a change to the appointment.

6. The method as claimed in claim 1 wherein the sending a consumer request includes sending a service provider parameter, a location parameter, and a time parameter.
